(19) United States
(12) Patent Application Publication
(10) Pub. No.: US 2011/0279329 A1
(43) Pub. Date: Nov. 17, 2011

(54) ROOF ANTENNA DESIGNED FOR MOUNTING ON A VEHICLE ROOF OF A VEHICLE

(76) Inventors: Tobias Kleinert, Reutlingen (DE); Christian Gerneth, Kirchentellinsfurt (DE)

(21) Appl. No.: 12/672,900

(22) PCT Filed: Sep. 26, 2008
(86) PCT No.: PCT/EP2008/008221

§ 371 Date: Mar. 23, 2010

(30) Foreign Application Priority Data
Sep. 27, 2007 (DE) 10 2007 046 129.3

(51) Int. Cl. H01Q 1/22

(52) U.S. Cl. 343/702

(57) ABSTRACT

The invention relates to a roof antenna (1) designed for mounting on a vehicle roof (2) of a vehicle, wherein the roof antenna (1) comprises an antenna element (4) disposed on a base plate (3) and an antenna housing (5) for protecting the antenna element (4) from outside influences, wherein the antenna housing (5) encompasses the base plate (3) with the circulating bottom edge thereof. According to the invention, either the base plate (3) is formed from an organic material or plastic, at least in a region that is not sealed off from outside influences or the base plate (3) is formed by a core region (31) made of metal, at least in a region that is not sealed off from outside influences, wherein the core region (31) is coated with a non-metal material (30), at least in said region.

The invention relates to a roof antenna designed for mounting on a vehicle roof of a vehicle, according to the features of the preamble of patent claim 1 or 2.

DE 10 2006 050 424 A1 discloses a roof antenna which has a base plate, with antenna elements being arranged on the base plate. The antenna elements are protected against external influences by an antenna housing, with the antenna housing surrounding the base plate by way of its peripheral lower edge. In this prior art, it is necessary to take complicated measures to ensure that the antenna housing tightly surrounds the base plate by way of its peripheral lower edge in order to prevent particles of dirt and primarily moisture from entering the interior of the roof antenna. This is because moisture leads to corrosion and consequently to malfunctions, primarily in the radio-frequency antenna elements which are very sensitive to such moisture. Therefore, the prior art discloses that the base plate is usually produced from the material zinc using a die-casting method. However, without further treatment, zinc has the property that it corrodes under the action of moisture, and therefore measures have to be taken to prevent such destructive corrosion. In the prior art, this is done by passivation operations, for example by means of thick-film passivation, so that the base plate is protected against corrosion. During this passivation process, the surface of the base plate is treated by means of a chemical process, and therefore the surface region of the base plate can no longer corrode. However, this step is extremely damaging from an environmental point of view and is very complicated in terms of executing production and passivation of base plates for roof antennas in series production in large numbers.

The invention is therefore based on the object of providing a roof antenna having a base plate, in the case of which roof antenna the disadvantages described in the introduction no longer occur and the base plate is protected against corrosion in a simple manner and using simple means when moisture enters the antenna housing during operation of the roof antenna on the vehicle roof of a vehicle.

This object is achieved by means of the features of independent patent claims 1 and 2.

According to a first refinement of the invention, provision is made for the base plate to be formed from an organic material or from plastic in a region which is not sealed off from the external influences. This firstly has the advantage that sealing measures, for example by virtue of sealing elements, through interlocking or force-fitting connections between the antenna housing and the base plate can be completely dispensed with or minimized. Secondly, the method step of passivation can be dispensed with during production of the roof antenna having the base plate since the base plate is formed from a material which cannot corrode after production and during operation of the antenna.

In an alternative refinement of the invention, the base plate is formed from metal, for example zinc, in a region of a core region which is not sealed off from the external influences, with the core region being coated with a non-metallic material. The advantage that sealing measures can be minimized or dispensed with is also firstly provided in this case. A further advantage is that the base plate can firstly be produced without having to be treated further by chemical method steps. This is because production of the base plate is followed by the method step of the base plate being coated with a non-metallic material, for example a plastic. As an alternative, the base plate can also be painted, for example. This means that, in this additional method step, the surface of the base plate is not changed, in particular is not damaged, but an additional material which prevents corrosion of the metallic base plate is merely applied.

In one development of the invention, the surface which is applied to the base plate and comprises the organic material, the plastic or the non-metallic material is at least partially, preferably completely, provided with an additional metallic coating. An additional metallic layer of this type is required in order to form a ground contact area or a ground area (possibly also with the effect of a shield) for the roof antenna, in particular for the antenna elements of the roof antenna. This metallic coating of the surface of the material, which protects the base plate itself from corrosion, can be applied, for example, using a printing or spraying method. A printing method has the advantage that those regions of the surface, in particular of the flat surface, which are intended to function as ground areas or ground contact areas can be provided with the metallic material in a targeted manner. To this end, a metallic paste is used in particular, the metallic paste being applied to the desired regions of the surface of the coating of the base plate. As an alternative or in addition to this, the additional metallic layer can also be applied using a spraying method, with the spraying method having the advantage that the entire coated surface of the base plate can be provided with the additional metallic coating in a simple manner. This is then performed in a very simple and brief processing step.

As an alternative or in addition to this, provision is made, according to the invention, for the metallic coating to be applied to a component which is separate from the base plate and can be attached to the base plate. This means that, after the base plate has been completely produced from plastic or an inorganic material or the core region has been coated with the non-metallic material, the base plate is subsequently provided with a separate component which is, for example, likewise in the form of a plate and has the contours of the base plate. This may be performed, for example, by clipping, adhesive bonding, screwing, soldering or the like. Connection of the separate component to the base plate also has the advantage that the connection points are in the form of contact points, and therefore contact can be made with the antenna elements, ground points and the like, which are arranged on the base plate, via the separate component (can also be designated metal ground plate) depending on the function of the antenna elements, ground points and the like, and possibly further with the vehicle roof or further components of the vehicle. Both the base plate and the component which is separate from the base plate are particularly advantageously formed from the metallic material such that they are flat and that the outer contours of the base plate and component are virtually identical or completely identical, and therefore the base plate and separate component can be laid one above the other in the form of a sandwich and attached to one another or contact-connected.

In one development of the invention, provision is made for the organic material, the plastic or the non-metallic material which surrounds the core region of the base plate, that is to say the metallic base plate itself, to be arranged such that it is injection-molded, at least partially, in particular completely, for example on one side of the base plate or such that it completely surrounds the base plate. This means that the organic material, the plastic or the non-metallic material can be applied to the base plate using a processing method which is easy to handle, specifically an injection-molding method.

The base plate is always coated with the materials in a region which, in the mounted state of the roof antenna on the vehicle roof, is exposed to the external environmental influences, in particular moisture, when there are no sealing elements or despite the presence of sealing elements. Furthermore, even those regions in which the base plate is not exposed to the external influences on account of the design of the roof antenna or on account of the presence of effective sealing elements are protected by the measures. This is taken into consideration particularly when water of condensation which would lead to the undesired instances of corrosion could be produced despite extremely careful sealing of the interior of the roof antenna.

The flat base plate is preferably coated with a relatively thin coating, in particular with a thickness of less than 1 mm (millimeter). That is to say, the other elements of the roof antenna, in particular the antenna elements, are not affected by the coating since they are mounted only after the base plate is coated with the materials. However, it is also feasible for the base plate to be produced from a metallic material, in particular zinc, then for the antenna elements to be mounted in a suitable form and only then for the base plate to be coated by the entire antenna housing, that is to say its entire interior, being filled with the electrically conductive material, for example an inorganic material or plastic, in order to protect the base plate and, in a further advantageous manner, the other elements within the roof antenna against corrosion. At this point, it can also be borne in mind that the base plate having the mounted antenna elements and possibly other elements, for example feed lines, plug-type connections or the like, are coated with a suitable material, for example a plastic, a paint or the like, after they are finally mounted, in order to thus also protect the interior of the roof antenna against corrosion.

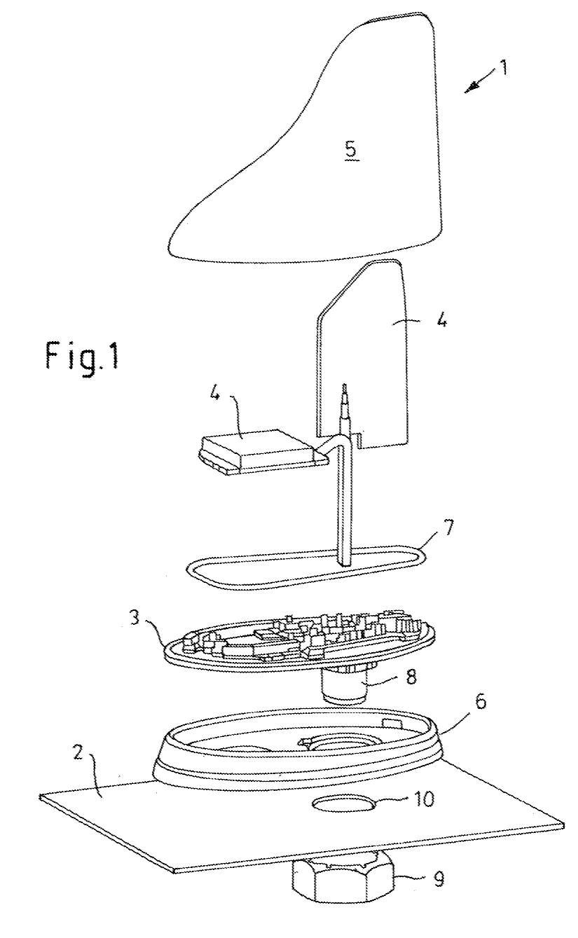

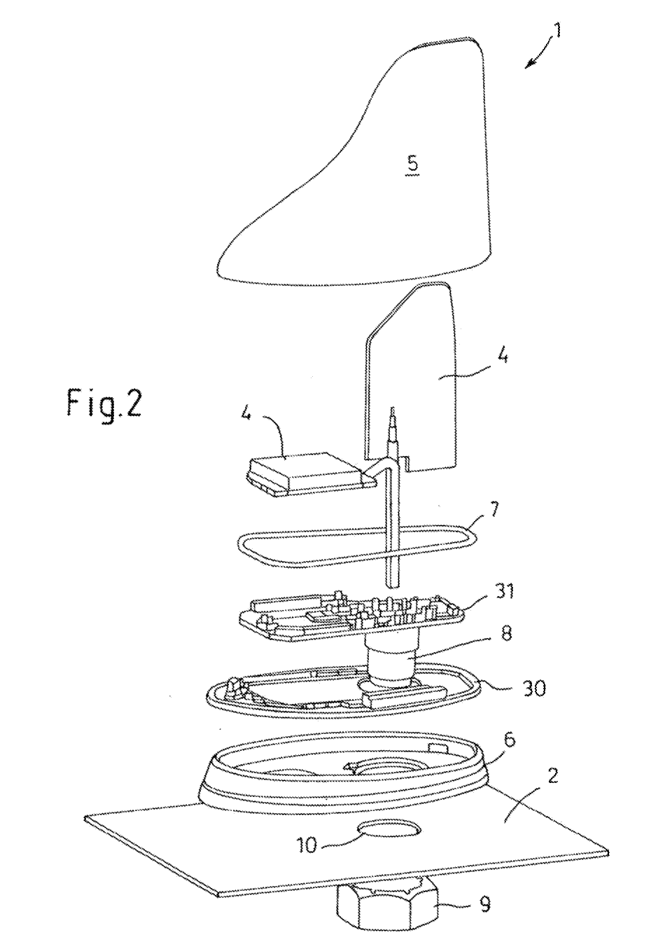

Two illustrated embodiments are described in the text which follows and explained with reference to FIGS. 1 and 2; however the invention is not restricted to the illustrated embodiments.

FIGS. 1 and 2 show, to the extent that they are illustrated in detail, a roof antenna 1 which, after all the elements have been mounted, is designed for mounting on a vehicle roof 2 of a vehicle. The design of the antenna as a roof antenna and mounting of the antenna on a vehicle roof of a vehicle is the main application, it also being possible, as an alternative, to take into consideration other geometric embodiments and other mounting sites on flat components of a vehicle instead of the design as a roof antenna and mounting on a vehicle roof. One example of an alternative mounting site of an antenna of this type is, for example, a trunk lid of a vehicle.

FIGS. 1 and 2 illustrate a base plate 3, with, in FIG. 1, the base plate 3 forming a single component and, in an inventive manner, being formed in a region which is not sealed off from the external influences but is formed, preferably completely, from an organic material or from plastic. An antenna element 4 or a plurality of antenna elements 4 for various services (that is to say frequency bands) is/are mounted on the base plate 3, with the interior of the roof antenna 1 being closed off by an antenna housing 5 and therefore being protected against external influences. In this case, the peripheral lower border (edge) of the antenna housing 5 surrounds the base plate 3, and for this reason the adjacent regions are designed in a corresponding manner in order to permanently or detachably secure the antenna housing 5 to the base plate 3. The antenna housing can be detachably secured by, for example, screw or clip connections, and permanently secured, for example, by welding or adhesive bonding, it being advantageous in the last-mentioned case for the material of the coating of the base plate 3 and the material of the antenna housing 5 to be identical, in order to facilitate a welding or adhesive bonding process. For the purpose of providing sealing measures, it is also possible, but not necessary, for a sealing element 7 to be provided, the sealing element sealing off the antenna housing 5 from the base plate 3 and/or possibly sealing off the base plate from the surface of the vehicle roof 2 with the aid of a further sealing element. In the illustrated embodiment according to FIGS. 1 and 2, a support 6 is also provided, the support preferably also comprising a plastic material, for example produced using an injection-molding method, with the support 6 being arranged on the vehicle roof 2 and accommodating the base plate 3.

The base plate 3 has, in a manner which is known per se, a threaded journal 8 which points in the direction of the vehicle roof 2, it being possible for at least one fastening nut 9 to be screwed onto the threaded journal 8 after the threaded journal 8 has been passed through an opening 10 in the vehicle roof 2. Cables and possibly plug-type connections, which connect the antenna elements to downstream radio-frequency devices, for example to an antenna amplifier, an impedance converter or reproduction devices, are also passed through the opening 10 in the vehicle roof 2. In the case of known roof antennas, the roof antenna is connected to ground via the threaded journal and the fastening nut by being connected to the vehicle roof which is generally composed of a metallic material and is at ground potential. In order to likewise ensure this function according to the invention, it is advantageous for the base plate 3 to also be coated with the metallic material after having been coated with the material which is intended to prevent corrosion, in order to ensure this so-called connection to ground.

In order to achieve the design of the base plate 3 according to FIG. 1, the base plate is to be designed such that it is of integral form and comprises an electrically non-conductive material. This material is, for example, a plastic which is processed using an injection-molding method and, after the method has been performed, produces the finished base plate 3 in the desired form.

In order to achieve the design of the base plate 3 according to FIG. 2, the base plate is to be designed such that it has a metal core region 31, with this core region 31 being formed, for example, by a zinc plate or from another metallic material in plate form, it being possible to produce this core region 31 preferably using a die-casting method. After the production of the core region 31 of the base plate 3, the core region is then coated with a non-metallic material 30, for example by applying a paint or inserting the as yet unfinished core region 31 into an injection mold which is filled with plastic and of which the mold forms the outer contours of the subsequently finished base plate 3. This refinement is shown in an exploded illustration in FIG. 2 in order to clearly explain the configuration of the extrusion coating. The part with the threaded journal 8, with the plate-like part and the threaded journal forming the so-called core region 31, comprises a metallic material, with the part 30 illustrated directly beneath it being designed such that this extrusion coating accommodates the internal seals and likewise lies against the lower seal in the direction of the support 6, so that the metal part (the upwardly pointing region of part 31) is sealed off against the environment after the sealed antenna housing 5 is put into position. It should be noted here that the two parts 30, 31 in FIG. 2 are illustrated as two separate parts only to improve understanding. In practice, these two parts are realized by firstly the metallic part 31 with its threaded journal 8 being produced and then, as already described above, being extrusion-coated with plastic in a die-casting mold, so that, after this extrusion-coating process, an integral part 30, 31 is produced, in which the two parts 30, 31 which are positioned separately in FIG. 2 only for demonstrative purposes, can no longer be separated from one another without being destroyed.

The base plate 3, which has been produced completely from plastic according to FIG. 1, or the base plate 3 according to FIG. 2 (comprising the core region 31 with its extrusion coating 30) furthermore have elements which can accommodate the antenna elements 4, that is to say that fix the antenna elements in their position on the base plate 3 and furthermore also have an attachment function, for example by means of clipping.

For the sake of completeness, it should also be noted that the geometric refinements and extensions of the base plate 3 follow the external shape of the antenna housing 5, the external shape being selected from a design point of view with reference to the overall appearance of the vehicle. Therefore, it is particularly advantageous, but not necessary, for the base plate 3, which either completely comprises an inorganic material or plastic (FIG. 1) or comprises a metal core region 31 with a non-metallic coating 30, to have a flat plate shape. It goes without saying that, as an alternative or in addition to this, other shapes are also feasible, for example upward and/or downward angled portions, thicker or block-like refinements of the base plate 3 and the like.

In one particular refinement of the invention, the base plate 3 according to FIG. 1 or FIG. 2 is provided with a support 6, the antenna element 4 or the antenna elements 4 are mounted, then the antenna housing 5 is connected to the base plate 3 and/or to the support 6 by way of its peripheral lower edge, and then the entire inner region within the antenna housing 5 is filled with a suitable material, for example a liquid plastic which hardens after it is processed, so that both the base plate 3 is coated and also all the other components within the antenna housing 5 are protected against corrosion. Furthermore, filling the inner region of the antenna housing 5 has the advantage that both corrosion is prevented and also the elements within the antenna housing 5 are fixed in their desired position and are therefore effectively protected against vibrations, bumps and the like.

List of reference symbols

| | |
|---|---|
| 1. | Roof antenna |
| 2. | Vehicle roof |
| 3. | Base plate |
| 4. | Antenna elements |
| 5. | Antenna housing |
| 6. | Support |
| 7. | Sealing element |
| 8. | Threaded journal |
| 9. | Fastening nut |
| 10. | Opening |

1. A roof antenna designed for mounting on a vehicle roof of a vehicle, with the roof antenna having antenna elements, which are arranged on a base plate, and also an antenna housing for protecting the antenna elements against external influences, with the antenna housing surrounding the base plate by way of its peripheral lower edge, the base plate being formed from an organic material or from plastic at least in a region which is not sealed off from the external influences.

2. A roof antenna designed for mounting on a vehicle roof of a vehicle, with the roof antenna having antenna elements, which are arranged on a base plate, and also an antenna housing for protecting the antenna elements against external influences, with the antenna housing surrounding the base plate by way of its peripheral lower edge, the base plate being formed from metal at least in a region of a core region which is not sealed off from the external influences, with the core region being coated with a non-material at least in this region.

3. The roof antenna as claimed in claim 1 wherein the surface comprising the organic material, the plastic or the non-metallic material is at least partially provided with a metallic coating.

4. The roof antenna as claimed in claim 3, wherein the metallic coating is applied to the base plate or to a component which is separate from the base plate and can be attached to the base plate.

5. The roof antenna as claimed in claim 1 wherein the organic material, the plastic or the non-metallic material is extrusion-coated at least partially onto the base plate.

6. The roof antenna as claimed in claim 1 wherein the organic material is a paint.

7. The roof antenna as claimed in claim 1 wherein the base plate has a threaded journal, with the threaded journal also comprising the organic material, the plastic or the non-metallic material and at least partially being provided with a metallic coating.

8. The roof antenna as claimed in claim 2 wherein the surface comprising the organic material, the plastic or the non-metallic material is at least partially provided with a metallic coating.

9. The roof antenna as claimed in claim 8, wherein the metallic coating is applied to the base plate or to a component which is separate from the base plate and can be attached to the base plate.

10. The roof antenna as claimed in claim 2 wherein the organic material, the plastic or the non-metallic material is extrusion-coated at least partially onto the base plate.

11. The roof antenna as claimed in claim 2 wherein the organic material is a paint.

12. The roof antenna as claimed in claim 2 wherein the base plate has a threaded journal, with the threaded journal also comprising the organic material, the plastic or the non-metallic material and at least partially being provided with a metallic coating.
